(19) United States
(12) Patent Application Publication
(10) Pub. No.: US 2021/0016155 A1
(43) Pub. Date: Jan. 21, 2021

(54) GAMING METHOD AND APPARATUS

(71) Applicant: CLUB GAMING PTY LTD, Southbank, Victoria (AU)

(72) Inventors: Daryl BRUCE, Southbank, Victoria (AU); Paula STEWART, Southbank, Victoria (AU)

(21) Appl. No.: 16/483,512

(22) PCT Filed: Feb. 6, 2018
(86) PCT No.: PCT/AU2018/000014

§ 371 Date: Aug. 5, 2019

(30) Foreign Application Priority Data
Feb. 6, 2017 (AU) 2017900351
Mar. 29, 2017 (AU) 2017901126

(51) Int. Cl. A63F 1/00

(52) U.S. Cl. CPC A63F 1/00; A63F 2001/005

(57) ABSTRACT

The application relates to a card game utilizing chance in the draw of cards that provides wagering options with a range of payouts and allows for active player participation. Examples include (i) providing a playfield including a gaming layout adapted for location and/or placement of at least two playing card elements and a wagering layout having indicia representing at least two possible characteristics of the playing card elements, (ii) accepting placement of a wager through use of the wagering layout indicia to nominate one or more of the possible characteristics, (iii) drawing a first playing card element and nominating one of its characteristics as a determinant characteristic, (iv) sequentially drawing subsequent card elements to generate an outcome including the number of subsequent playing card elements drawn in an uninterrupted sequence having the same characteristic as the determinant characteristic, and (iv) settling the wager on the basis of the generated outcome.

### RELATED APPLICATIONS

This application claims priority to Australian Provisional Patent Application No. 2017900351 in the name of Club Gaming Pty Ltd, which was filed on 6 Feb. 2017, entitled “Card Game Method and Apparatus” and Australian Provisional Patent Application No. 2017901126 in the name of Club Gaming Pty Ltd, which was filed on 29 Mar. 2017 also entitled “Card Game Method and Apparatus” and the specifications thereof are incorporated herein by reference in their entirety and for all purposes.

### FIELD OF INVENTION

The present invention relates to a method and apparatus for a card game and, more particularly, to a method and apparatus for a card game utilising chance in the draw of cards that provides simplified wagering options with a broad range of payouts and allows for improved active player participation. It will be convenient to hereinafter describe the invention in relation to a table card game that uses four decks in one embodiment, however more or less decks can be used, and it should be appreciated that the present invention is not limited to that use, only.

The invention may find application in casinos, gaming venues, cruise ships online gambling sites, and also in non-gambling sites, as well as games provided for social media websites, personal computers and mobile applications.

### BACKGROUND ART

The discussion throughout this specification comes about due to the realisation of the inventor and/or the identification of certain related art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

In order to attract new players, and maintain the interest of existing patrons, casinos and other gaming operators periodically offer new games of skill and chance utilising different chance mediums, such as cards, rotating reels in slot machines, rotating wheels in roulette, or dice, for example. A majority of the new games do not find popular appeal amongst players, and the reasons for such failures typically relate to common wagering game shortcomings. Typical shortcomings include slow pace of play, complex rules, poor player odds and, in some cases, the lack of a significant jackpot or large payout opportunity. Particular drawbacks include a lack of ease of play for patrons that will avoid the drop off in interest that can apply to games with high levels of complexity.

Consider, for example, the game of Casino War™ which is a casino card game based on the well-known card game called “War”. The game is one of the most easily understood casino card games, and may be considered as one of the only card games where players can beat the dealer more than fifty-percent of the time. The game has the advantages that it is easy to learn, is fast paced, and provides a high frequency of winning for the player. As a result, it has succeeded as a game for new players, particularly with those unfamiliar with table games. However, the game lacks suspense and is not very exciting for players. Moreover, the game does not provide a good range of betting options. By way of example, given the betting on the player card being higher in each successive round, it is not possible to choose the dealer card being higher. The range and size of payouts is also limited.

Another game that has found success amongst new players unfamiliar with table games is the “Big Wheel”, where a large vertically oriented wheel is divided into sections, and each section is represented by a symbol. The game is very easy to learn, it is suspenseful and exciting, allows for multiple bets, and provides a range of payout odds providing large payouts. It also allows for the possibility of selecting the winning outcome on every round. Regrettably, however, due to the nature of the wheel it spins slowly, which is not optimal for both player interest and gaming operator turnover.

Numerous card games exist. Many players, however, do not wish to invest the time necessary to learn all of these games, including their intricate set of house-specific variations. Further, many players find these card games slow and inactive. Some games are objected to by players because play is against other players, and not against the house.

A game that is fast and offers much player excitement is the dice game known as “Craps”. This game involves the throwing of two dice. Unfortunately, the game is complex and difficult to learn, deterring many from playing it. For the gaming operator, Craps is also relatively labour intensive, typically requiring four staff dedicated to a table, where other table games may require only one. Casino floor space is a valuable asset, but a Craps table requires double the space required by, for example, a Blackjack table. Moreover, staff training is more complicated due to betting and payout complexities.

There are a number of table game variations available that are not adapted to or made in standard sizes and may require the buyer to purchase a full table of customised design and dimensions.

With respect to games utilising dice there exists the children's dice game of Tenzi™ that has been promoted by Carma Games LLC. Typically, in this game of 2 to 4 players, each player chooses a set of ten (10) dice. In one common form of this game, to begin players hold all ten dice in their hands and all players roll their dice at the same time. Each player must quickly look at their roll and decide which number they are going to go for. For example, if a player has more 3's than any other number, that will be the number that player will want to aim for. Putting all dice with that number aside, the player collects the remaining dice and quickly rolls again. Players do not have to wait for others to roll again. Everyone rolls together only on the first roll. Players keep rolling until all ten of their dice show the same number. The first player to get all ten of their dice to match (ten 3's, for example) shouts out “TENZI” and wins the game. Essentially, the object of this game is to achieve a full matching set of ten dice. This game does not appeal to a broad range of adult players.

U.S. Pat. No. 4,222,572 (Baker) discloses a card deck variation comprising high and low red and black cards, high cards having indicia thereon and low cards lacking such indicia, and high cards of a third color, preferably gold or silver. In a preferred deck, there are 16 low red cards, 16 low black cards, 8 high red cards, 8 high black cards, and 4 high gold cards. Baker also discloses a game board playing surface for selecting or guessing different cards or hands of the card deck variation to be dealt by a dealer. Baker provides a non-standard deck of cards with their own peculiar values for essentially three options of card paly comprising: card draw for closest to 21; accumulation of the greater number of red/black specific cards with an option of throwing undesired cards away and; a bidding game on individual card draw.

U.S. Pat. No. 6,158,741 (Koelling) discloses a method of playing blackjack with a side wager which is typically set at $1 per hand per player. Where the dealer shows a card having a value of ten, and the player shows two cards having a cumulative value of twenty, the player is a winner. Where either of these two conditions are not met, the player loses the side wager. Where the dealer has a ten-value up card and the player has two cards totalling twenty including aces and nines, the player wins a first amount. Where the player's cards are both of the same suit, the player wins a second, typically larger, amount. Where the player's cards are of the same rank, e.g. both Kings, the player wins a third amount. Where the player's cards are both the same rank and the same suit, the player wins a fourth amount. Where the player's cards are both the same suit and the same rank, and also the same suit and rank as the dealer's face up card, the player wins a significantly larger fifth amount. Where both of the player's cards and both of the dealer's cards are the same, e.g. all Queens of diamonds, then the player wins the jackpot. Because the game is played with multiple decks of cards, such an occurrence is possible. The game is adapted to both casino table, computer and video gaming device play.

In view of the foregoing, it would thus be desirable to provide a new wagering process for a card game that is easy to learn and play, involves no procedural decisions to be made by the player or dealer, offers simplified betting opportunities with a broad spectrum of payout values, and may be adaptable to an electronic form and/or existing table forms.

### SUMMARY OF INVENTION

It is an aim of the present invention to provide an improved method and apparatus for conducting a wagering process together with a card game, or simulations thereof. In particular, the present invention aims to address one or more of the issues outlined hereinabove, or at least provide a useful alternative that facilitates enhanced player participation in games.

In one aspect of embodiments the present invention provides a method of conducting a wagering process comprising the steps of:

(i) providing a playfield including a gaming layout adapted for location and/or placement of at least two or more playing card elements and a wagering layout having indicia representing at least two possible distinct characteristics of the playing card elements;
(ii) accepting placement of a wager through use of said wagering layout indicia to nominate one or more of the at least two possible characteristics;
(iii) drawing a first playing card element and nominating one of its characteristics as a determinant characteristic of a round of play;
(iv) sequentially drawing subsequent card elements to generate an outcome comprising the number of subsequent playing card elements drawn in an uninterrupted sequence having the same characteristic as the determinant characteristic up to a predefined maximum number of drawn cards;
(iv) settling the wager on the basis of the generated outcome.

The playing card elements may be physical playing cards or graphical representations of playing cards. In preferred embodiments, the characteristics may comprise one or a combination of:

playing card colour;

playing card value or;

playing card suit.

The predefined maximum number of drawn cards may be any appropriate number but in a preferred embodiment is seven (7).

In one variation of the outcome generated by the subsequent draw of card elements, the number of subsequent playing card elements drawn in an uninterrupted sequence having the same characteristic as the determinant characteristic may, in fact, be zero.

In the step of settling the wager, game outcomes that are subject to successful wagers may utilise the following pay table:

| Generated | Pay |
|---|---|
| outcome | multiple |
| 0 | Lose |
| 1 | Push |
| 2 | 1 to 1 |
| 3 | 2 to 1 |
| 4 | 3 to 1 |
| 5 | 4 to 1 |
| 6 | 5 to 1 |
| 7 | 6 to 1 |

In a preferred embodiment, where a generated outcome of an uninterrupted sequence of drawn card elements has the same suit an additional payout may be provided as follows:

| Maximum Number | |
|---|---|
| of any Suit | Pays |
| 1 | Lose |
| 2 | Push |
| 3 | 3 to 1 |
| 4 | 5 to 1 |
| 5 | 10 to 1 |
| 6 | 25 to 1 |
| 7 | 50 to 1 |

In another embodiment, where a generated outcome of an uninterrupted sequence of drawn card elements has the same suit an additional payout as follows may be provided:

| Maximum Number | |
|---|---|
| of any Suit | Pays |
| 1 | Lose |
| 2 | Push |
| 3 | 3 to 1 |
| 4 | 5 to 1 |
| 5 | 10 to 1 |
| 6 | 25 to 1 |
| 7 | 100 to 1 |

In certain embodiments, one or more of the method steps are implemented by computer simulation.

In still another aspect of embodiments there is provided apparatus for conducting a wagering process comprising:

a playfield including a gaming layout adapted for location and/or placement of at least two or more playing card elements and a wagering layout having indicia representing at least two possible distinct characteristics of the playing card elements and for accepting placement of a wager to nominate one or more of the at least two possible characteristics;
the gaming layout adapted for displaying the sequential drawing of a first card element having one of its characteristics nominated as a determinant characteristic of a round of play and subsequent card elements to generate an outcome comprising the number of subsequent playing card elements drawn in an uninterrupted sequence having the same characteristic as the determinant characteristic up to a predefined maximum number of drawn cards.

In yet another aspect of embodiments there is provided apparatus for conducting a wagering process comprising:

electronic processing means adapted to simulate the drawing of at least two card elements;
a display controlled by the electronic processing means, the display operatively depicting a playfield, the playfield including a gaming layout adapted for location and/or placement of at least two or more playing card elements and a wagering layout having indicia representing at least two possible distinct characteristics of the playing card elements and for accepting placement of a wager to nominate one or more of the at least two possible characteristics, the gaming layout further adapted for displaying the sequential drawing of a first card element having one of its characteristics nominated as a determinant characteristic of a round of play and subsequent card elements to generate an outcome comprising the number of subsequent playing card elements drawn in an uninterrupted sequence having the same characteristic as the determinant characteristic up to a predefined maximum number of drawn card elements,
and;
an input device in operative communication with the electronic processing means by which a player may place wagers in relation to a plurality of game results presented on the playfield, wherein the electronic processing means is programmed to pay out wagers placed in relation to matching final game results according to predetermined payout ratios.

In further embodiments, the above described apparatus comprising electronic processing means is furthermore incorporated into an electronic gaming machine network comprising a plurality of such operably connected electronic gaming apparatus.

In essence, embodiments of the present invention stem from the realization that a simple game does not necessarily need to lack suspense and excitement. Through intelligent design and game rules and specifically rules that result in the gradual, successive revealing of cards, an otherwise simple game could be made incredibly suspenseful and exciting. A unique aspect of the games provided by the present invention is in the mechanical action of dealing a single set of cards for all players, which continues until a streak, preferably of 7 cards or a change of colour, occurs.

Advantages provided by the present invention comprise the following:

A choice of betting options is allowed, which maintains excitement for players.

A game that is easy to learn and has an element of camaraderie.

A game that provides a strong sense of anticipation as the outcome of the game is dependent on having a long streak of like cards having the same characteristic, ie colour, that is revealed one by one.

A game that is adaptable to either a traditional table game, semi-automated table game or fully automated table game, electronic gaming machine, mobile game or computer game (online or offline).

A simplified game in as much as having very few betting options but with each option offering a broad range of payouts depending on the outcome.

A game with unique new mechanics and mathematics that offers a choice of betting options.

From the perspective of a game or casino operator, there is an advantage with the invention over other games as in preferred forms the invention only requires the provision of a printed felt, to be fitted over a standard sized D shaped table. This will overcome the disadvantages of certain existing game variations that are not made in standard sizes and may require the buyer to purchase a full table.

The simplicity of play for embodiments of the invention as mentioned below and herein are main drawcards for attracting players.

No intra-game decisions are required to be made by players.

### BRIEF DESCRIPTION OF THE DRAWINGS

Further disclosure, objects, advantages and aspects of the present invention may be better understood by those skilled in the relevant art by reference to the following description of exemplary embodiments taken in conjunction with the accompanying drawings, which are given by way of illustration only, and in which:

FIG. 1 is a schematic depicts a gaming table layout according to a first described embodiment of the present invention;

FIG. 2 depicts an alternate table layout according to a further described embodiment of the invention;

FIG. 3 is an image of the table gaming layout of FIG. 1 as it would appear on a printed felt adapted for a gaming table according to an exemplary embodiment of the present invention;

FIG. 4 is an image of the table gaming layout of FIG. 2 as it would appear on a printed felt adapted for a gaming table according to an exemplary embodiment of the present invention;

FIG. 5 illustrates another table gaming layout as it would appear on a printed felt adapted for a gaming table according to another exemplary embodiment of the present invention.

### DETAILED DESCRIPTION

The present invention relates to a method and apparatus for conducting a wagering process or gambling in a card game. The invention may be implemented using actual cards including one or more decks of cards, or simulated on electronic gaming machines, computers or other electronic devices. The invention is suitable for commercial use in casinos or other gaming establishments, in non-gaming establishments or for individual use.

In a preferred form the present invention is implemented as a standalone table game that is not based on or reliant upon the result of any other proprietary table game. The game may be played with between one and eight decks of cards, each deck having 52 cards without jokers.

Preferred embodiments of the card game of the invention take the form of a card game that is easy to learn and play, based on building a streak or run of cards. The card game provides a sense of community and camaraderie with fellow patrons. It is also adaptable to an electronic form and involves no intra game decisions to be made by the patron or dealer, with the possibility of selecting the winner outcome in every round.

In a preferred form, the game is reliant on a streak of cards of the same colour. By this it should be understood that same coloured means either Black (Clover and Spade) or Red (Diamond or Hearts). Due to the game relying on having a streak of same coloured cards being dealt, and due to the way in which the cards are revealed i.e. one by one, a strong sense of anticipation and suspense is generated while playing the game.

The objective of the game for each player is to choose which colour, Red or Black, will form the streak, or uninterrupted run of like cards, for that round of play, and place a wager on that colour.

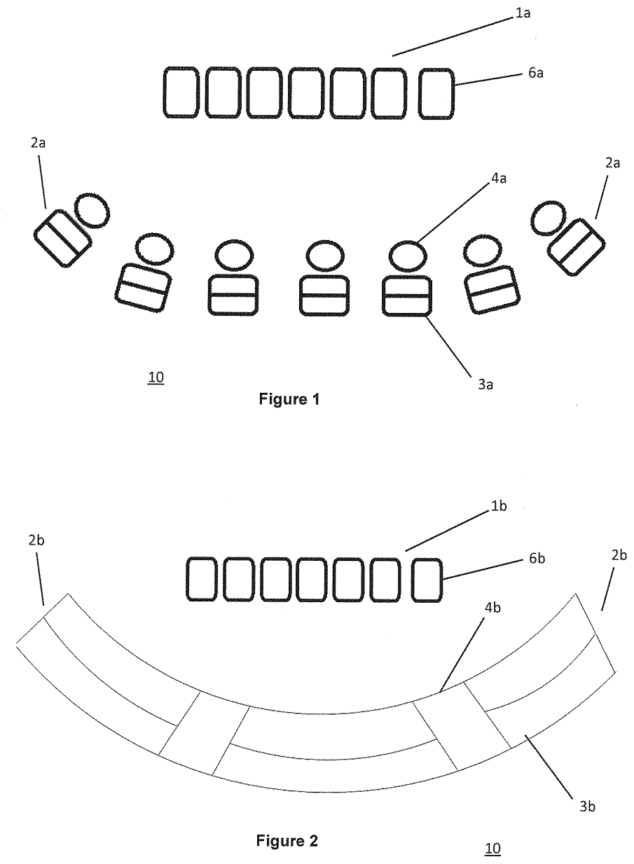

A typical and general form of table layout that is suitable for embodiments of the invention is shown in FIG. 1 where the table is indicated at 10. With reference to FIG. 1, in the course of play of the game, players will be given the opportunity to place a bet on either, or both, of ‘RED’ or ‘BLACK’ and this is accomplished by the provision of the player betting boxes indicated with reference numeral 2a and where each betting box has two demarcated regions 3a for designating ‘RED’ or ‘BLACK’. In the alternate embodiment of FIG. 2, the player betting boxes are indicated with 2b and the demarcated regions are indicated with 3b. After the dealer announces “no more bets”, a single card is dealt face up to the ‘streak’ box 6a in FIGS. 1 and 6b in FIG. 2 located in front of the dealer. The characteristic of this drawn card, ie its colour, will nominate the ‘streak’ for that round of play. Accordingly, the colour of the streak card determines the colour of the streak that is wagered upon for that round. Subsequent cards are then drawn one-by-one and arranged face up in the subsequent card boxes 1a in FIGS. 1 and 1b in FIG. 2, until either:
a. a card of the opposing colour of the streak colour is drawn, or
b. a nominal total maximum of cards of the streak colour are drawn. In the embodiments illustrated in the accompanying figures that maximum is seven cards in total including the initial ‘streak’ card can be drawn.
   Either of these two events will complete the round of play.

Bets placed on RED or BLACK are paid according to the below pay table, with the number of streak cards dealt determining the payout for that round:

| Streak | |
|---|---|
| of Cards | Pays |
| 0 | Lose |
| 1 | Push |
| 2 | 1 to 1 |
| 3 | 2 to 1 |
| 4 | 3 to 1 |
| 5 | 4 to 1 |
| 6 | 5 to 1 |
| 7 | 6 to 1 |

With reference to the above pay table and using an example $5 wager, a Push of such a $5 bet means the player keeps their $5 bet. A ‘1 to 1’ return means the player wins an additional $5 on top of their existing $5. A ‘2 to 1’ return means the player wins an additional $5×2=$10 on top of their existing $5, and so on. As indicated, if no streak cards are dealt then the player's wager is lost. By taking the preferred form where the nominated characteristic is colour as an example, if a player makes a wager on ‘Red’ only and the dealer draws an initial Black card, ie the ‘streak’ card is Black, then the player loses their bet straight away. In this circumstance, the player's streak of cards is 0 and they lose their bet. If however the dealer draws an initial Red ‘streak’ card, then the player would have a streak of 1. If then the second card drawn is Black, the player would be paid out according to their streak of 1, which is a push in this instance. If instead the second card drawn is Red, then the player would still remain in the game, and would be paid either 1 to 1 or above, depending on how many successive streak cards are drawn in a continuous sequence that are red. In this respect, the initially drawn ‘streak’ card is to be considered as part of the total of 7 cards drawn in the round. Generally, in the event of a push result, this is to be taken as meaning that there is effectively a ‘non-result’ in as much as “push” refers to the result of a bet that results in the equivalent of a tie or draw. A push occurs when there is no winner and no loser in a bet. If a player has made a bet that winds up in a push that player will get all of their wagered amount back. There is no commission or penalty taken off a wager and the house makes nothing. It is effectively as if the bet was never placed.

In a variation of embodiments of the invention, players may also be given the opportunity to place what is referred to as a ‘Suit Up’ side wager prior to the commencement of play. The Suit Up side wager pays according to the maximum number of cards dealt of any particular suit, within the ‘streak’ cards dealt in that round of play. Bets placed on the Suit Up side wager are settled according to the below pay table:

| Maximum Number | |
|---|---|
| of any Suit | Pays |
| 1 | Lose |
| 2 | Push |
| 3 | 3 to 1 |
| 4 | 5 to 1 |
| 5 | 10 to 1 |
| 6 | 25 to 1 |
| 7 | 50 to 1 |

An alternate pay table for the ‘suit up’ wager is as follows:

| Maximum Number | | |
|---|---|---|
| of any Suit | P(X) | Pays |
| 1 | 62.92% | Lose |
| 2 | 24.27% | Push |
| 3 | 8.55% | 3 to 1 |
| 4 | 3.16% | 5 to 1 |
| 5 | 0.90% | 10 to 1 |
| 6 | 0.18% | 25 to 1 |
| 7 | 0.02% | 100 to 1 |

Where P(X) is the probability of the outcome. For the avoidance of doubt, Suit Up side wagers are independent of whether the ‘streak’ for that round of play is made of Red or Black cards. Players make their wager on suit up by placing chips or tokens in the suit up region indicated as 4a in FIG. 1 or 4b in FIG. 2.

Three variations of physical implementation are proposed for the ‘streak’ game:

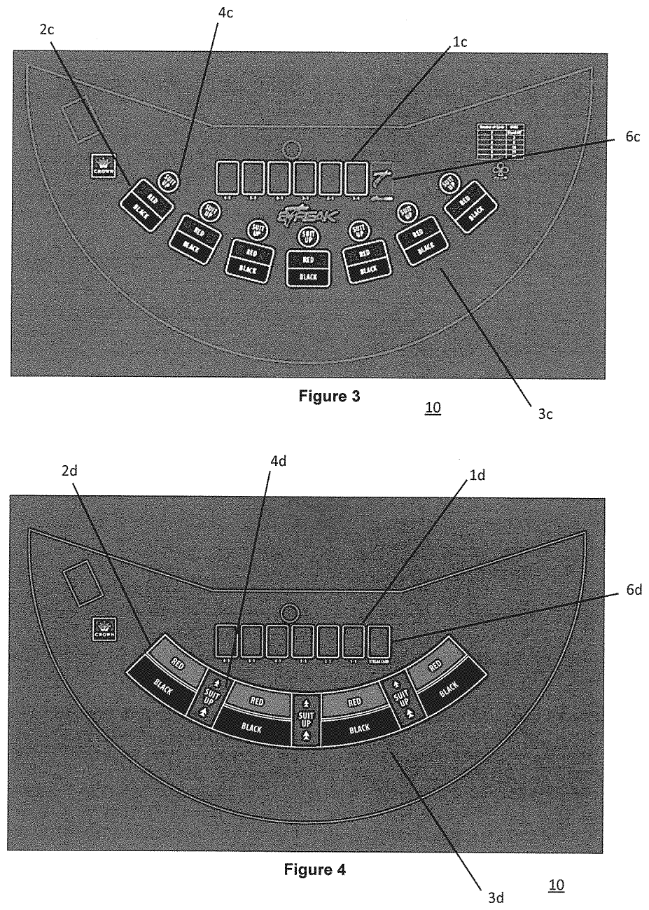

Firstly, with reference to FIGS. 1 and 3, a D-Shaped table layout is employed with individual player boxes 2a in FIGS. 1 and 2c in FIG. 3 where each individual player box 2a, 2c is divided into two regions 3a or 3c in FIGS. 1 and 3 respectively for red or black. In this variation individual betting boxes 2a, 2c are provided for each player position with up to 5-7 positions. Layout modifications may be employed as would be understood by the person skilled in the art. Cards can be dealt from a shoe (using 2+ decks), or dealt by hand (1 deck).

With reference to FIGS. 2 and 4, another variation is a D-Shape with communal betting boxes 2b in FIGS. 2 and 2d in FIG. 4. The betting boxes 2b, 2d can contain bets from multiple players, or from players in any position seated or standing around the table 10. Again the layout may be modified but remain functional for this embodiment as would be appreciated by the person skilled in the art. As with the embodiments of FIGS. 1 and 3, cards may be dealt from a shoe (using 2+ decks), or dealt by hand (1 deck).

In a third variation of a physical implementation of the invention, an electronic table game version may be utilised. This involves a screen interface to be determined by any number of characteristics but conveying the functional regions employed by the above noted embodiments. An eTG terminal allows patrons to place bets via electronic interface. Further, embodiments of the game could be delivered by; live dealer, automated card dealing mechanism, or via animated electronic dealer. An online version of the game could also be implemented, with players playing for real money, with social credits, or for free.

Due to the limited betting options, the game is very simple and easy to learn. Due to there being no intra game decisions and only up to seven cards dealt, the game is very fast paced

In addition, the invention can be readily implemented as a computer program product (e.g., floppy disk, compact disc, memory stick, etc.) comprising a computer readable medium having control logic recorded therein to implement the features of the invention as described in relation to the other preferred embodiments. Control logic can be loaded into the memory of a computer and executed by a central processing unit (CPU) to perform the operations described herein.

In this context, an electronic gaming arrangement may be configured and employed for playing the game according to the invention. Such apparatus may include a display means, a player interface, and circuitry such as a CPU for effecting game play according to the rules of the game. The operation of electronic gaming machines in general, such as slot machines and video poker machines, is well known in the industry so that the minute details are not set forth herein. In general terms, electronic gaming machines are controlled by processors including, or in communication with, a random number generator. The random number generator ultimately determines the game outcomes, in this case the draw of cards. A display in communication with the processor provides visual and graphic information to players. The processor then controls the game play and associated operations, including tracking wagers and payouts.

The general external features of the gaming machine may include a display, coin slot and/or banknote reader, a card reader and a credit display. The gaming machine may also include several player buttons which act as interfaces between the player and the machine processor, such as for making wager selections and amounts, and for invoking a round of card play. It is noted that any of the functions facilitated by the gaming machine buttons can alternatively be accomplished using a display employing touch-screen technology.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive. For example, in addition to the embodiments described hereinabove, it is also envisaged that embodiments of the invention may be implemented in a ‘not for real money’ gaming form online. For example, as a mobile app playing with virtual coins. Alternatively, an implementation may be through a social media platform such as Facebook where these may or may not include a virtual currency, that monetises by selling virtual currency [called ‘pay to play’] which players may use to play more casino games. Furthermore, whereas embodiments described cater for up to seven players, other embodiments within the scope of the invention as defined in the appended claims may cater for five or less players. In yet another example, another embodiment could have the same general elements of the game but a different paytable than the ones already mentioned. For instance, in another variation, once a first card element is drawn and a determinant characteristic is nominated for the round of play, the outcome generated by the subsequent draw of card elements being the number of subsequent playing card elements drawn in an uninterrupted sequence having the same characteristic as the determinant characteristic may, in fact, be zero. In other words, in this scenario once a first playing card element is drawn and one of its characteristics is nominated as the determinant characteristic of a round of play, the next card element drawn will not have a characteristic that matches the determinant characteristic. Players may be offered the opportunity to place a wager on this ‘no match’ outcome.

A summary of payouts for embodiments of the present invention is shown in the following table.

| | Subsequent number of cards of the same colour as the Streak Card (i.e. Length of Streak): | | | | | | |
|---|---|---|---|---|---|---|---|
| | 1 Card | 2 Cards | 3 Cards | 4 Cards | 5 Cards | 6 Cards | 7 Cards |
| Streak Card: Black | | | | | | | |
| Black wager | Stand off | 1 to 1 | 2 to 1 | 3 to 1 | 4 to 1 | 5 to 1 | 6 to 1 |
| Streak Card: Red | | | | | | | |
| Red wager | Stand off | 1 to 1 | 2 to 1 | 3 to 1 | 4 to 1 | 5 to 1 | 6 to 1 |

| NAME | DESCRIPTION | PAYOUT ODDS |
|---|---|---|
| No | Streak Card and first subsequent card are | 1 to 1 |
| Streak | of opposing colour and do not form a Pair. | |
| | Streak Card and first subsequent card are | Stand off |
| | of opposing colour and form a Pair. | |

| | Total number of cards of the same suit: | | | | | |
|---|---|---|---|---|---|---|
| | 2 cards | 3 cards | 4 cards | 5 cards | 6 cards | 7 cards |
| Suit Up | Stand off | 3 to 1 | 5 to 1 | 10 to 1 | 25 to 1 | 100 to 1 |

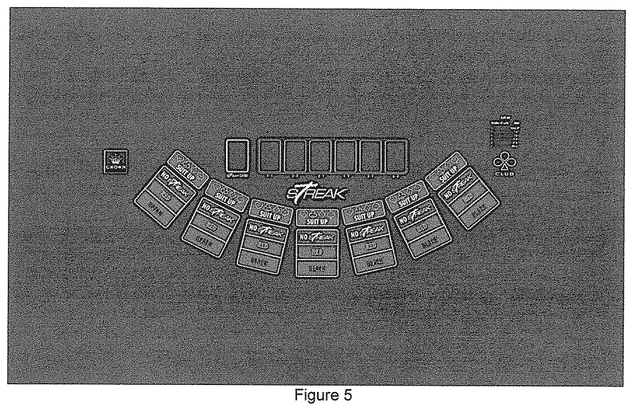

A table layout suitable for accommodating each of the above pay out events of the above table is shown in FIG. 5.
The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of” each of the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

We claim:

1. A method of conducting a wagering process comprising the steps of:
(i) providing a playfield including a gaming layout adapted for location and/or placement of at least two or more playing card elements and a wagering layout having indicia representing at least two possible distinct characteristics of the playing card elements;
(ii) accepting placement of a wager through use of said wagering layout indicia to nominate one or more of the at least two possible characteristics;
(iii) drawing a first playing card element and nominating one of its characteristics as a determinant characteristic of a round of play;
(iv) sequentially drawing subsequent card elements to generate an outcome comprising the number of subsequent playing card elements drawn in an uninterrupted sequence having the same characteristic as the determinant characteristic up to a predefined maximum number of drawn cards;
(iv) settling the wager on the basis of the generated outcome.

2. A method as claimed in claim 1, wherein the playing card elements are physical playing cards or graphical representations of playing cards.

3. A method as claimed in claim 1, wherein the characteristics comprise one or a combination of:
playing card colour;
card value or;
playing card suit.

4. A method as claimed in claim 1, wherein the predefined maximum number of drawn cards is seven (7).

5. A method as claimed in claim 1, wherein the number of subsequent playing card elements drawn in an uninterrupted sequence having the same characteristic as the determinant characteristic is zero.

6. A method as claimed in claim 1 wherein the step of settling the wager utilises the following pay table:

| Generated | Pay |
|---|---|
| outcome | multiple |
| 0 | Lose |
| 1 | Push |
| 2 | 1 to 1 |
| 3 | 2 to 1 |
| 4 | 3 to 1 |
| 5 | 4 to 1 |
| 6 | 5 to 1 |
| 7 | 6 to 1 |

7. A method as claimed in claim 3, where within a generated outcome an uninterrupted sequence of drawn card elements having the same suit provides an additional payout as follows:

| Maximum Number | |
|---|---|
| of any Suit | Pays |
| 1 | Lose |
| 2 | Push |
| 3 | 3 to 1 |
| 4 | 5 to 1 |
| 5 | 10 to 1 |
| 6 | 25 to 1 |
| 7 | 50 to 1 |

8. A method as claimed in claim 3, where within a generated outcome an uninterrupted sequence of drawn card elements having the same suit provides an additional payout as follows:

| Maximum Number | |
|---|---|
| of any Suit | Pays |
| 1 | Lose |
| 2 | Push |
| 3 | 3 to 1 |
| 4 | 5 to 1 |
| 5 | 10 to 1 |
| 6 | 25 to 1 |
| 7 | 100 to 1 |

9. A method as claimed in claim 1, wherein one or more of the method steps are implemented by computer simulation.

10. (canceled)

11. (canceled)
